(19) United States
(12) Patent Application Publication
(10) Pub. No.: US 2019/0354904 A1
(43) Pub. Date: Nov. 21, 2019

(54) DATA PROCESSING METHOD AND DEVICE FOR SEATING CHANGE

(71) Applicant: Alibaba Group Holding Limited, Georgetown (KY)

(72) Inventor: Chungang DING, Beijing (CN)

(21) Appl. No.: 16/414,520

(22) Filed: May 16, 2019

(30) Foreign Application Priority Data
May 17, 2018 (CN) 201810474208.5

(51) Int. Cl. G06Q 10/02; G06F 16/29; G06Q 20/14

(52) U.S. Cl. CPC G06Q 10/02; G06Q 20/14; G06F 16/29

(57) ABSTRACT

A computer implemented data processing method, system and device for making seating changes at a venue, the method comprising: acquiring seat change requests from users, wherein the seat change request comprises location data regarding a location change and fee data regarding a fee change; selecting a first seat change request of a first user, wherein the first seat change request has a highest change fee; determining one or more matching seat change requests corresponding to the first seat change request based on a predetermined matching policy; and executing the first seat change request and the one or more matching seat change requests. By the present invention, seating change requests can be obtained for a centralized computer match arrangement, thereby enhancing users' convenience by enabling multi-user participation in making seating changes.

### PRIORITY CLAIM

This patent application claims priority to China Patent Application No. 201810474208.5 filed May 17, 2018 herein incorporated by reference in its entirety.

### TECHNICAL FIELD

The present invention relates generally to the field of data processing and more particularly to a data processing method, data processing system and an electronic device for making seating changes.

### BACKGROUND

With the development of the economy, in addition to the production of industry, people's demands for more cultural activities also need to be met. At the same time, in order to promote cultural exchanges and development, more and more large-scale cultural events such as various performance activities have been held.

After purchasing a seat ticket for a concert, e.g., a user may want to change the seat for some reason, and such seat change may involve multiple parties (more than 2 users are involved).

For example, a user A purchased 1 seat ticket a1 for a concert, a user B purchased 1 seat ticket b1, and a user C purchased 1 seat ticket c1. However, now user A wants to get the ticket c1, the user B wants to get the ticket a1 and user C wants to get the ticket b1.

In the foregoing scenario, if the contacts of the users are only the contacts between two users, any two users cannot meet the request of each other, and they cannot learn the request of a potential third person (or more), as there is a circular dependency among three users, the transaction will fail. Therefore, there is a need for an improved solution for making seating change in this context.

### SUMMARY

Embodiments of the present invention provide a data processing method, a data processing device and an electronic device, for making seating change. By the present invention, seating change requests from users can be obtained for a centralized match arrangement, thereby enhancing user convenience by enabling multi-participation seat changes.

According to an aspect of the present invention, the present invention provides a data processing method for making seating changes, comprising: acquiring seat change requests of all users, wherein the seat change request comprises location data regarding a location change and fee data regarding a change fee; selecting a first seat change request of a first user, wherein the first seat change request has a highest change fee; determining one or more matching seat change requests corresponding to the first seat change request based on a predetermined matching policy; and executing the first seat change request and the one or more matching seat change requests.

In the data processing method for making seating changes mentioned above, the step of determining one or more matching seat change requests corresponding to the first seat change request based on the predetermined matching policy comprises: determining transaction fees corresponding to the first seat change request and the one or more matching seat change requests; and determining the one or more matching seat change requests corresponding to the first seat change request by a transaction fee based fee matching policy.

In the data processing method for making seating changes mentioned above, the transaction fee based fee matching policy comprises: a sum of the transaction fees corresponding to the one or more matching seat change requests is minimum; the transaction fee corresponding to the first seat change request is a predetermined fee based on the location data; the transactions fee corresponding to each request of gain (or upgrade request) among the first seat change request and the one or more matching seat change requests is respectively less than or equal to a payable amount of the corresponding user (or a maximum amount the user will pay to upgrade); and the transaction fee corresponding to each request of loss (or downgrade request) among the first seat change request and the one or more matching seat change requests is respectively greater than or equal to a receivable amount of the corresponding user (or a minimum amount the user will accept to downgrade).

In the data processing method for making seating changes mentioned above, the predetermined fee is an average actual change fee or a default change fee based on the location data.

In the data processing method for making seating changes mentioned above, prior to executing the first seat change request and the one or more matching seat change requests, the method further comprises: verifying whether a user confirmation corresponding to the first seat change request and the one or more matching seat change requests is received.

In the data processing method for making seating changes mentioned above, prior to executing the first seat change request and the one or more matching seat change requests, the method further comprises: locking the first seat change request and the one or more matching seat change requests in the seat change requests of all users.

In the data processing method for making seating changes mentioned above, the location data further comprises data regarding mutual positional relationships among a plurality of seats.

In the data processing method for making seating changes mentioned above, the location data further comprises data regarding information of people in adjacent locations after seat change.

According to another aspect of the present invention, the present invention provides a data processing device for making seating changes, comprising: an acquiring unit for acquiring seat change requests of all users, wherein the seat change request comprises location data regarding a location change and fee data regarding a change fee; a selecting unit for selecting a first seat change request of a first user, wherein the first seat change request has a highest change fee; a determining unit for determining one or more matching seat change requests corresponding to the first seat change request based on a predetermined matching policy; and an executing unit for executing the first seat change request and the one or more matching seat change requests.

In the data processing device for making seating changes mentioned above, the determining unit is used for: determining transaction fees corresponding to the first seat change request and the one or more matching seat change requests; and determining the one or more matching seat change requests corresponding to the first seat change request by a transaction fee based fee matching policy.

In the data processing device for making seating changes mentioned above, the transaction fee based fee matching policy comprises: a sum of the transaction fees corresponding to the one or more matching seat change requests is minimum; the transaction fee corresponding to the first seat change request is a predetermined fee based on the location data; the transactions fee corresponding to each request of gain (or upgrade request) among the first seat change request and the one or more matching seat change requests is respectively less than or equal to a payable amount of the corresponding user (or a maximum amount the user will pay to upgrade); and the transaction fee corresponding to each request of loss (or downgrade request) among the first seat change request and the one or more matching seat change requests is respectively greater than or equal to a receivable amount of the corresponding user (or a minimum amount the user will accept to downgrade).

In the data processing device for making seating changes mentioned above, the predetermined fee is an average actual change fee or a default change fee based on the location data.

In the data processing device for making seating changes mentioned above, the device further comprises: a verifying unit, for verifying whether a user confirmation corresponding to the first seat change request and the one or more matching seat change requests is received, prior to executing the first seating change request and the one or more matching seat change requests.

In the data processing device for making seating changes mentioned above, the device further comprises: a locking unit, locking the first seat change request and the one or more matching seat change requests in the seat change requests of all users, prior to executing the first seat change request and the one or more matching seat change requests.

In the data processing device for making seating changes mentioned above, the location data further comprises data regarding mutual positional relationships among a plurality of seats.

In the data processing device for making seating changes mentioned above, the location data further comprises data regarding information of people in adjacent locations after seat change.

In yet another aspect of the present invention, the present invention provides an electronic device, comprising: a processor; and a memory in which is stored a computer program instruction, the computer program instruction, when executed by the processor, causing the processor to perform the data processing method for making seating changes as mentioned above.

The present invention provides a data processing method, a data processing device and an electronic device for making seating changes. By the present invention, the seat change requests from all users can be obtained for the centralized match arrangement, thereby enhancing user convenience by enabling multi-participation of seat changes.

### BRIEF DESCRIPTION OF DRAWINGS

Various other advantages and benefits of the present invention will become apparent to a person of ordinary skill in the art through reading the detailed description of the preferred embodiments of the present invention. The drawings are only for the purpose of illustrating the preferred embodiments and are not to be considered as limiting the present invention. As can be appreciated, the drawings described below are only some of the embodiments of the present invention, and other drawings may be obtained by a person of ordinary skill in the art without involving inventive skills based on this invention. In addition, the same components are denoted by the same reference numerals throughout the drawings.

FIG. 1 shows a flow chart of a data processing method for making seating changes according to an embodiment of the present invention.

FIG. 2 shows a flowchart of a process of determining a reference price in a data processing method for making seating changes according to an embodiment of the present invention.

FIG. 3 shows a schematic diagram of a specific example of a data processing method for making seating changes according to an embodiment of the present invention.

FIG. 4 shows a block diagram of a data processing device for making seating changes according to an embodiment of the present invention.

FIG. 5 shows a block diagram of an electronic device according to an embodiment of the present invention.

### DETAILED DESCRIPTION

### Embodiments

Hereinafter, exemplary embodiments according to the present invention will be described in detail with reference to the accompanying drawings. It will be apparent that the described embodiments are only a part of the embodiments of the present invention, and are not intended to limit the present invention.

As described above, for a user who has purchased a ticket of a large event or activity, such as a concert, when the user wants to change the seat, it may be necessary to involve multiple parties (two or more users), resulting in a high transaction complexity.

Moreover, since a single user cannot effectively acquire and process the seat location change information of the entire event or activity, it often results in a seat change transaction that involves multiple parties' failures.

In view of the technical problems mentioned above, the basic idea of the present invention is to provide a data processing method, a data processing device and an electronic device for making seat change, which is able to acquire the seat change requests from all users, and then starts from the seat change request that has the highest change fee, determine one or more matching seat change requests, accordingly, the seat change requests from all users can be obtained for the centralized match arrangement for the potential seat exchange transaction involving a plurality of parties. In addition, for the data processing method, the data processing device, and the electronic device for making seat changes, the fee matching policy is established in consideration of the fee required by the user request and the fee that the user is willing to pay, thereby completing the multi-party transaction at the lowest fee.

It should be noted that the above basic concept of the present invention can be applied to various types of activities, including concerts, large conferences and the like. Moreover, in addition to the venues with fixed seats, the present invention may also be applied to the temporary locations without fixed seats such as the seat change of the users in open-air venues.

Having described the basic principles of the present invention, various non-limiting embodiments of the present invention will be described below in detail with reference to the accompanying drawings.

### Exemplary Method

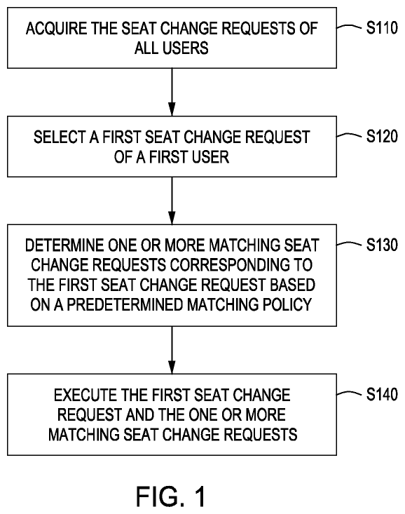

FIG. 1 shows a flow chart of a data processing method for seat change request according to an embodiment of the present invention. As shown in FIG. 1, the data processing method for seat change request according to an embodiment of the present invention includes the following steps: S110, acquiring seat change requests of all users, wherein the seat change request comprises location data regarding a location change and fee data regarding a change fee; S120, selecting a first seat change request of a first user, wherein the first seat change request has a highest change fee; S130, determining one or more matching seat change requests corresponding to the first seat change request based on a predetermined matching policy; and S140, executing the first seat change request and the one or more matching seat change requests.

In step S110, the seat change requests of all users are obtained. Herein, a user's seat change request can be in various specific or non-specific forms, for example, a user can specify a seat to be changed to, and in many other cases, a user may only specify the area that he or she wishes to change. For example, a user specifies that “I want to switch to area A,” or more vaguely, “I want to be closer to the stage.” However, regardless of the form of a user's seat change request, it is necessary to include the contents of two aspects.

First, a seat change request includes a user's request for a change the location of a seat, that is, a user's requirement on the location of the seat change. Specifically, the user asks for upgrading the seat or downgrading the seat, the seat of a specific grade or level, does the user have certain specific requirement, such as close to the aisle. In addition, when the user wants to change a plurality of seats at a time, are the seats to be changed located together or the seats to be changed are in adjacent rows, and may also include the information about whether the target seats can be separated by 1 to 2 seats, and the like.

That is, in the data processing method for seat change request according to an embodiment of the present invention, the position data further includes the data regarding the location relationship of a plurality of seats.

Moreover, the seat change request also includes a fee requirement for seat change. Specifically, for a user who wants to upgrade the seat, the fee data relates to the amount the user is willing to pay for such upgrade, such as in the form of the highest payable payment. For a user who wants to downgrade the seat, the fee data relates to the amount of the compensation that is acceptable for such a downgrade, for example in the form of a minimum acceptable amount. In addition, other than upgrade or downgrade the seat, for the seats of the same grade, although the sale prices of the seats are the same, based on the specific needs of the users, there may be differences in the actual value of the seats. For example, for the seats of the same grade, the seats of the front row can be more valuable relative to the seats of the rear row, or the seats near the center can be more valuable than the seats near the two ends.

Therefore, even for the seats of the same grade, the value of the seats can be calculated according to the specific needs of the users. For example, if a user is willing to pay a payment in order to change the seat to a location of the same grade but near the aisle, then the target seat of the change can be considered to have a seat value higher than the value of the seat to be changed.

In an exemplary matching process, a user's gain or loss can be determined by the system based on the seat values of the respective seats. Thus, when a user's seat change request is received, the system only needs to obtain the highest payable amount or the lowest receivable amount of the user. The specific matching process based on the obtained user fee data and the seat values determined by the system will be further described in detail.

Further, in a user's seat change request, an additional request may also be included, for example, the request for the person on a seat adjacent to the seat changed to. For example, a user may provide the request on the persons of the next seats, or the adjacent seats, such as age, gender, interest, city, and marriage status of the persons. However, in contrast to the above location data and fee data, these additional requirements are considered to be the unnecessary requests for a seat change transaction. That is to say, these additional user requirements will be met as much as possible in the process of matching, but they are not the necessary requirements for a transaction.

Therefore, in the data processing method for seat change request according to an embodiment of the present invention, the location data further includes data of person information of the persons on the adjacent seats after the seat change.

In step S120, select a first seat change request of a first user wherein the first seat change request has a highest change fee.

That is to say, in the data processing method for seat change request according to an embodiment of the present invention, the processing is started from a seat change request having the highest change fee, such as an upgrade fee or a downgrade fee. Because a user's request is usually a seat upgrade request, in the actual case, all user requests are usually sorted according to the fees, from high to low, for seat upgrades; and the processing procedure will start from the first or top request.

In step S130, determine one or more matching seat change requests corresponding to the first seat change request based on a predetermined matching policy.

For the present invention, in the data processing method for seat change request according to one embodiment of the present invention, after the seat change requests of all users are acquired, the seat change request of the user can be matched based on the location data and the fee data in the seat change request. For example, in the above case, the user A who originally purchased the ticket for the seat a1 wishes to change to the seat c1, the user B who has purchased the ticket for the seat b1 wishes to change to the seat a1, and the user C who has purchased the ticket for the seat c1 wishes to change to the seat b1. Then, select the seat change request of the user A who has purchased the seat a1 and wants to change to the seat c1, determine the two seat change requests corresponding to the foregoing seat change request, i.e., the seat change request of the user B of the seat b1 to change to the seat a1, and the seat change request of the user C of the seat c1 to change to the seat b1.

Moreover, if there are differences in the values of the seats a1, b1 and c1, the respective users may be charged in an amount as a payment or paid in an amount as compensation according to the seat values of different grades. For example, if the ticket for seat a1 is 280 yuan, the ticket for seat b1 is 680 yuan, and the ticket for seat c1 is 1,280 yuan, then user A will be charged a fee of 1,000 yuan, user B will be compensated for 400 yuan, and user C will be compensated for 600 yuan.

However, as noted above, in some cases, the value of each seat is not completely consistent with the seat value of that grade. Moreover, in some actual transaction processes, it may not be easy to facilitate a transaction if the user is charged or compensated only for the difference based on the grade value of the seat. For example, in some popular concerts, the number of the users who want to upgrade their seats can be significantly higher than the number of the users who want to downgrade their seats. Therefore, in such a case, it is necessary to further consider the transaction fee corresponding to each seat replacement request.

Therefore, in the data processing method for seat change request according to an embodiment of the present invention, the step of determining one or more matching seat change requests corresponding to the first seat change request based on the predetermined matching policy comprises: determining transaction fees corresponding to the first seat change request and the one or more matching seat change requests; and determining the one or more matching seat change requests corresponding to the first seat change request by a transaction fee based fee matching policy.

Specifically, for the selected first seat change request, firstly, all of the eligible candidate seat change requests will be searched for on the basis of the location data, and then, among the obtained candidate seat change requests, one or more seat change requests will be combined to meet the first seat change request.

First, for location matching, a complete closed loop needs to be formed by the one or more matching seat change requests.

Moreover, for fee matching, the following conditions need to be met:

First, the sum of the transaction fees of the determined plurality of matching seat change requests needs to be the smallest of the total transaction fees among all of the possible combinations, thereby ensuring that the price paid by the user who changed the seat is the lowest. Further, the fee paid by the user corresponding to the first seat change request is a predetermined fee based on the location data, for example, the fee for seat upgrade paid by the user requesting the seat upgrade is the fee for such upgrade determined by the system. Moreover, in such a combination, the fees paid by each of the parties of gain (or upgrade parties) need to be less than or equal to their preset maximum payable fees, and the fees received by all the parties of loss (or downgrade parties) need to be greater than or equal to their preset minimum receivable amount.

That is, in the data processing method for seat change according to an embodiment of the present invention, the transaction fee-based fee matching policy includes: a sum of the transaction fees corresponding to the one or more matching seat change requests is minimum; the transaction fee corresponding to the first seat change request is a predetermined fee based on the location data; the transactions fee corresponding to each request of gain (upgrade request) among the first seat change request and the one or more matching seat change requests is respectively less than or equal to a payable amount of the corresponding user (or a maximum amount the user will pay to upgrade); and the transaction fee corresponding to each request of loss (or downgrade request) among the first seat change request and the one or more matching seat change requests is respectively greater than or equal to a receivable amount of the corresponding user (or a minimum amount the user will accept to downgrade).

In the data processing method for seat change request according to an embodiment of the present invention, after the fee expectations of all the parties of gain (or upgrade parties) in the transaction and the all the parties of loss (or downgrade parties) in the transaction are satisfied, the fee actually paid by the first user can be minimized as much as possible. At the same time, in order to ensure fairness of the transaction, the fee paid by the first user should be as consistent as possible with the transaction fee of other users with similar requests. Therefore, based on the location change request of the user to change the seat, the transaction fee of the first user is determined by the system.

Therefore, in the data processing method for seat change request according to an embodiment of the present invention, the predetermined fee is an average actual change fee or a default change fee based on the location data.

That is to say, taking the user seat upgrade request as an example, the fee that the first user needs to pay is the current average seat upgrade price. In addition, it is also possible to preset a reference price for the seat grade change.

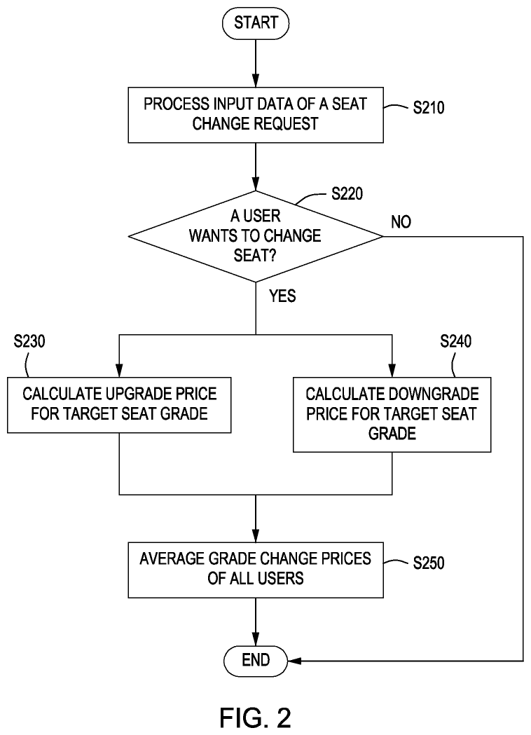

FIG. 2 shows a flowchart of a process of determining a reference price in a data processing method for seat change request according to an embodiment of the present invention. As shown in FIG. 2, the foregoing process includes: S210: processing input data of a seat change request; S220, determining whether the user requests to change seat; S230, in response to the user request to change seat, calculate the upgrade fee for the target seat grade based on the user's original seat value and quantity and the highest payable amount for such a gain (or upgrade) in seat grade; S240, in response to the user's request to change seat, calculate the downgrade fee for the target seat grade based on the user's original seat value and quantity and the lowest receivable amount for such a loss (or downgrade) in seat grade; S250, average the prices for seat grade change of all the users so as to obtain the reference price for seat grade change.

In addition, in the data processing method for seat change request according to one embodiment of the present invention, after the seat change requests of all users have been completed, that is, all the transactions are actually completed, the actual price of the seat grade change on the day can be obtained. In addition, the actual price of the historical seat grade change can be further obtained from the historical data of the transactions. Thus, the predetermined fee may also be a default seat change fee based on one or more of the above settings.

Moreover, in the data processing method for seat change request according to an embodiment of the present invention, prior to executing the first seat change request and the one or more matching seat change requests, the method further comprises: verifying whether a user confirmation corresponding to the first seat change request and the one or more matching seat change requests is received.

In other words, it can be set that all seat change request transactions need user confirmation, and the transaction will take effect in real time upon receipt of the user confirmation.

Moreover, in the data processing method for seat change request according to an embodiment of the present invention, wherein prior to executing the first seat change request and the one or more matching seat change requests, the method further comprises: locking the first seat change request and the one or more matching seat change requests in the seat change requests of all users.

That is to say, after the requests matching process, the transaction that has already been conducted is locked in the list of seat change requests, thus the requests that have not been matched can be further matched in the process mentioned above. In this way, even if the above transaction has not been confirmed by the user, the system can continue to match other requests, thereby improving the matching efficiency of the system.

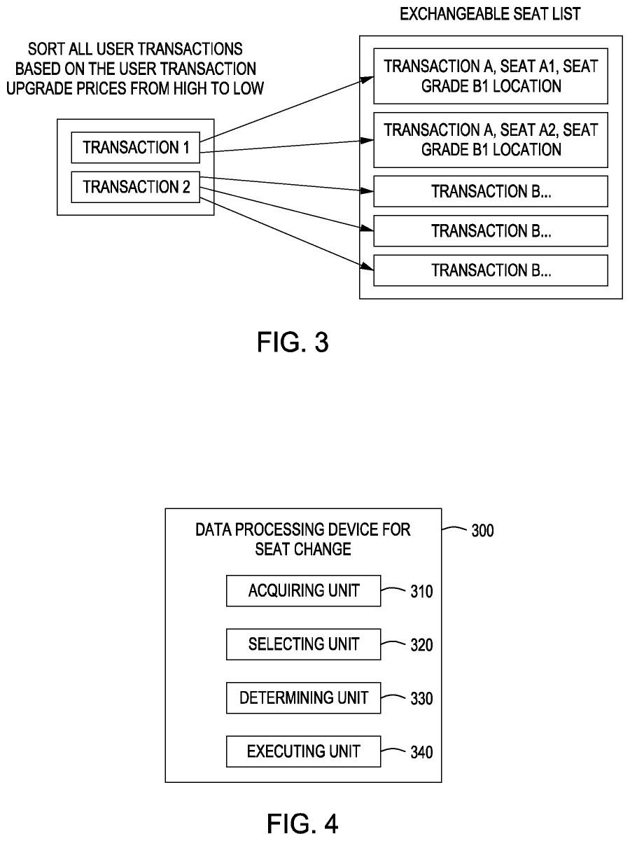

FIG. 3 shows a schematic diagram of a specific example of a data processing method for seat change request according to an embodiment of the present invention. As shown in FIG. 3, the data processing method for seat change according to an embodiment of the present invention is executed in two lists. In the list on the left, the user's upgrade transactions are arranged from top to bottom in order of highest to lowest price, while in the list on the right, all of the seats for change are listed. Then, based on the above process, match the first transaction in the list on the left and one or more entries of seat change in the list on the right, so as to form a transaction to be confirmed. After the transaction to be confirmed is reached, the related transaction is locked and will not participate in future matching process, and the transaction will be effective immediately after confirmation by all transaction users. Next, obtain the second transaction in the list on the left and continue the process.

For example, the prices of the seats of three grades are as follows: the price of seat a1 is 300 yuan, the price of b1 is 600 yuan, and the price of c1 is 1,000 yuan. The seat change requests of the three users are obtained as follows: user A, who has the seat a1, wants to change to the seat b1, is willing to pay up to 450 yuan; user B, who has the seat b1, wants to change to the seat c1, is willing to pay up to 800 yuan; user C, who has the seat c1, wants to change to the seat a1, is willing to receive a minimum amount of 700 yuan. Next sort according to the respect upgrade prices, the user B's transaction is first selected, then the location data of the transaction of the user B is used to match the transaction of the user C, and then the location data of the transaction of the user C is used to match the transaction of the user A. At this time, the location requests of the seats are satisfied. It belongs to a plurality of complete transactions. Next the costs of the three transactions are respectively examined; the user A can pay 450 yuan, the user B can pay 800 yuan, and the user C requests compensation of 700 yuan. Since 800+450>700, the payment and compensation conditions are generally met. For each user's fee, assuming that the user C gets 700 yuan, then the user B pays 700*(1,000−6,00)/1,000/7=400 yuan, and the user A pays 700*(600−300)/1,000/7=300 yuan. Of course, based on the seat value of each grade, it is also possible to allocate the transaction fees of the user A, user B, and user C in other ways while still satisfying the inequality of 800+450>700.

### Exemplary Device

FIG. 4 shows a block diagram of a data processing device for seat change request according to an embodiment of the present invention.

As shown in FIG. 4, the data processing device 300 for seat change request according to an embodiment of the present invention includes: an acquiring unit 310 for acquiring seat change requests of all users, wherein the seat change request comprises location data regarding a location change and fee data regarding a change fee; a selecting unit 320 for selecting a first seat change request of a first user among the seat change requests of all users obtained by the acquiring unit 310, wherein the first seat change request has a highest change fee; a determining unit 330 for determining one or more matching seat change requests corresponding to the first seat change request selected by the selecting unit 320, based on a predetermined matching policy; and an executing unit 340 for executing the first seat change request and the one or more matching seat change requests determined by the determining unit 330.

In one example, in the data processing device 300 for seat change request mentioned above, the determining unit 330 is used for: determining transaction fees corresponding to the first seat change request and the one or more matching seat change requests; and determining the one or more matching seat change requests corresponding to the first seat change request by a transaction fee based fee matching policy.

In one example, in the data processing device 300 for seat change request mentioned above, the transaction fee based fee matching policy comprises: a sum of the transaction fees corresponding to the one or more matching seat change requests is minimum; the transaction fee corresponding to the first seat change request is a predetermined fee based on the location data; the transactions fee corresponding to each request of gain (or upgrade request) among the first seat change request and the one or more matching seat change requests is respectively less than or equal to a payable amount of the corresponding user (or a maximum amount the user will pay to upgrade); and the transaction fee corresponding to each request of loss (or downgrade request) among the first seat change request and the one or more matching seat change requests is respectively greater than or equal to a receivable amount of the corresponding user (or a minimum amount the user will accept to downgrade).

In one example, in the data processing device 300 for seat change mentioned above, the predetermined fee is an average actual change fee or a default change fee based on the location data.

In one example, in the data processing device 300 for seat change request mentioned above, the device further comprises: a verifying unit, for verifying whether a user confirmation corresponding to the first seat change request and the one or more matching seat change requests is received, prior to executing the first seat change request and the one or more matching seat change requests.

In one example, in the data processing device 300 for seat change request mentioned above, the device further comprises: a locking unit, locking the first seat change request and the one or more matching seat change requests in the seat change requests of all users, prior to executing the first seat change request and the one or more matching seat change requests.

In one example, in the data processing device 300 for seat change request mentioned above, the location data further comprises data regarding mutual positional relationships among a plurality of seats.

In one example, in the data processing device 300 for seat change request mentioned above, the location data further comprises data regarding information of people in adjacent locations after seat change.

A person of ordinary skill in the art will understand that the specific functions and operations of the respective units and modules in the above-described data processing device 300 for seat change have been described in the data processing method for seat change described above with reference to FIGS. 1 to 3. Hence, the detailed description of the device will not be repeated herein.

As described above, the data processing device 300 for seat change request according to an embodiment of the present invention can be implemented in various terminal apparatuses, such as a server for running a ticketing system. In one example, the data processing device 300 for seat change in accordance with certain embodiments of the present invention may be integrated into a terminal device as a software module and/or hardware module. For example, the data processing device 300 for seat change may be a software module in an operating system of the terminal device, or may be an invention developed for the terminal device. Of course, the data processing device 300 for seat change can also be one of the numerous hardware modules of the terminal device.

Alternatively, in another example, the data processing device 300 for seat change request and the terminal device may also be separate devices, and the data processing device 300 for seat change may be connected to the terminal device by wired and/or wireless network, and transmits the interactive information in accordance with an agreed data format.

### Exemplary Electronic Device

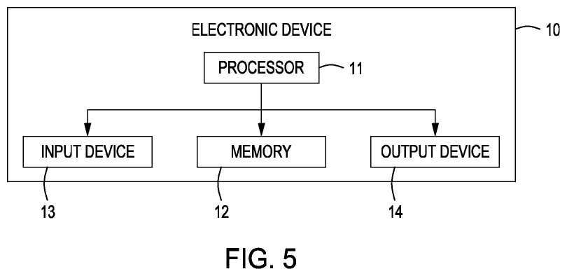

Next, an electronic device according to an embodiment of the present invention will be described with reference to FIG. 5. FIG. 5 shows a block diagram of an electronic device according to an embodiment of the present invention. As shown in FIG. 5, an electronic device 10 includes one or more processors 11 and one or more memories 12.

The processor 11 may be a central processing unit (CPU) or other form of processing unit with data processing capabilities and/or instruction execution capabilities, and may control other components in the electronic device 10 to perform the desired functions.

Memory 12 may include one or more computer program products, and the computer program product may include various forms of computer readable storage media, such as volatile memory and/or nonvolatile memory. The volatile memory may include, for example, a random access memory (RAM) and/or a cache or the like. The nonvolatile memory may include, for example, a read only memory (ROM), a hard disk, a flash memory, and the like. One or more computer program instructions may be stored on the computer readable storage medium, and the processor 11 may execute the program instructions to implement the data processing method for seat change according to various embodiments of the present invention as described above, and/or other desired functions. Various contents such as location data and fee data of the user's seat change request may also be stored in the computer readable storage medium.

In one example, the electronic device 10 may also include an input device 13 and an output device 14 that are interconnected by a bus system and/or other form of connection mechanism (not shown). For example, the input device 13 can be, for example, a keyboard, a mouse, and the like.

The output device 14 can output various information to the outside, including the transaction result of the user's seat change request, and the like. The output device 14 can include, for example, a display, a speaker, a printer, a communication network and a remote output device to which it is connected, and the like.

Of course, for simplicity, only some of the components of the electronic device 10 related to the present invention are illustrated in FIG. 5, while and components such as a bus, an input/output interface, and the like are omitted. In addition, the electronic device 10 may also include any other suitable components depending on the particular invention.

### Exemplary Computer Program Product and Computer Readable Storage Medium

In addition to the methods and devices described above, an embodiment of the present invention can also be a computer program product including computer program instructions that, when executed by a processor, cause the processor to perform the steps in the data processing method for seat change according to various embodiments of the present invention as described in the section “exemplary method” in this description.

The computer program product can write program code for performing the operations of the embodiments of the present invention in any combination of one or more programming languages. The programming language includes object oriented programming languages such as Java, C++, etc., as well as conventional procedural programming languages such as the “C” language or similar programming languages. The program code can be executed entirely on the user computing device, partially on the user device, as a stand-alone software package, partially on a remote computing device on a user computing device, or entirely on a remote computing device or server.

Furthermore, an embodiment of the present invention can also be a computer readable storage medium having stored thereon computer program instructions that, when executed by a processor, cause the processor to perform the steps in the data processing method for seat change according to various embodiments of the present invention as described in the section “exemplary method” in this description.

The computer readable storage medium can employ any combination of one or more readable mediums. The readable medium can be a readable signal medium or a readable storage medium. The readable storage medium may include, for example, but not limited to, an electronic, magnetic, optical, electromagnetic, infrared, or semiconductor system, apparatus, or device, or any combination of the above. More specific examples (non-exhaustive lists) of readable storage media include: electrical connections with one or more wires, portable disks, hard disks, random access memory (RAM), read only memory (ROM), erasable programmable read-only memory (EPROM or flash memory), optical fiber, portable compact disk read only memory (CD-ROM), optical storage device, magnetic storage device, or any suitable combination of the foregoing.

The basic principles of the present invention have been described above in reference with specific embodiments. However, it should be noted that the advantages, benefits, effects and the like mentioned in the present invention are merely examples and are not limiting, and such advantages, benefits, effects and the like are not necessarily required to be possessed by the various embodiments of the present invention. In addition, the specific details of the above disclosure are only for the purpose of description and easily understanding, and are not intended to limit the present invention to be implemented by employing the details mentioned above.

The block diagrams of the devices, apparatuses, equipment, and systems referred to in this invention are merely illustrative and are not intended to be required or implied to be connected, arranged, and configured in the manner as shown in the block diagram. As will be appreciated by those skilled in the art, these devices, apparatuses, equipment, and systems can be connected, arranged, and configured in any manner. Words such as “including,” “comprising,” “having,” and the like, are meant to mean “including but not limited to” and may be used interchangeably. The terms “or” and “and” are used herein to mean “and/or” and are used interchangeably unless the context clearly indicates otherwise. The term “such as” as used herein refers to a phrase “such as but not limited to” and is used interchangeably.

It should also be noted that in the devices, apparatus, and methods of the present invention, the various components or steps may be separated and/or combined. These separated and/or combined embodiments should be considered equivalents of the present invention.

The above description of the disclosed aspects is provided to enable any person skilled in the art to make or use the present invention. Various modifications to these aspects are obvious to those skilled in the art, and the general principles defined herein may be applied to other aspects without departing from the scope of the present invention. Therefore, the present invention is not intended to be limited to the aspects shown herein, but in the broadest scope consistent with the principles and novel features disclosed herein.

The foregoing description has been presented for purposes of illustration and description. Further, the description is not intended to limit the embodiments of the present invention to the forms disclosed herein. A number of exemplary aspects and embodiments have been discussed above; however those skilled in the art will understand that certain variations, modifications, changes, additions and sub-combinations of the present invention.

What is claimed:

1. A computer implemented data processing method for making seating changes, comprising:
acquiring seat change requests wherein the seat change request comprises location data regarding a location change and fee data regarding a change fee;
selecting a first seat change request from the seat change requests wherein the first seat change request has a highest change fee;
determining one or more matching seat change requests corresponding to the first seat change request based on a predetermined matching policy; and
executing the first seat change request and the one or more matching seat change requests.

2. The method of claim 1, wherein determining one or more matching seat change requests corresponding to the first seat change request based on the predetermined matching policy comprises:
determining transaction fees corresponding to the first seat change request and the one or more matching seat change requests;
determining the one or more matching seat change requests corresponding to the first seat change request by a transaction fee based fee matching policy.

3. The method of claim 2, wherein the transaction fee based fee matching policy comprises:
a sum of the transaction fees corresponding to the one or more matching seat change requests is minimum;
the transaction fee corresponding to the first seat change request is a predetermined fee based on the location data;
the transactions fee corresponding to each upgrade request among the first seat change request and the one or more matching seat change requests is respectively less than or equal to a maximum payable amount to upgrade; and
the transaction fee corresponding to each downgrade request among the first seat change request and the one or more matching seat change requests is respectively greater than or equal to a minimum receivable amount to downgrade.

4. The method of claim 3, wherein the predetermined fee is an average actual change fee or a default change fee based on the location data.

5. The method of claim 1, wherein prior to executing the first seat change request and the one or more matching seat change requests, the method further comprises:
verifying whether a confirmation corresponding to the first seat change request and the one or more matching seat change requests is received.

6. The method of claim 1, wherein prior to executing the first seat change request and the one or more matching seat change requests, the method further comprises:
locking the first seat change request and the one or more matching seat change requests in the seat change requests.

7. The method of claim 1, wherein the location data further comprises data regarding mutual positional relationships among a plurality of seats.

8. The method of claim 1, wherein the location data further comprises data regarding information of people in adjacent locations after seat change.

9. A data processing device for making seating changes, comprising:
an acquiring unit for acquiring seat change requests wherein the seat change request comprises location data regarding a location change and fee data regarding a change fee;
a selecting unit for selecting a first seat change request from the seat change requests wherein the first seat change request has a highest change fee;
a determining unit for determining one or more matching seat change requests corresponding to the first seat change request based on a predetermined matching policy; and
an executing unit for executing the first seat change request and the one or more matching seat change requests.

10. The data processing device for making seating changes of claim 9, wherein the determining unit is used for:
determining transaction fees corresponding to the first seat change request and the one or more matching seat change requests; and
determining the one or more matching seat change requests corresponding to the first seat change request by a transaction fee based fee matching policy.

11. The data processing device for making seating changes of claim 10, wherein the transaction fee based fee matching policy comprises:
a sum of transaction fees corresponding to the one or more matching seat change requests is minimum;
the transaction fee corresponding to the first seating change request is a predetermined fee based on the location data;
the transactions fee corresponding to each upgrade request among the first seat change request and the one or more matching seat change requests is respectively less than or equal to a maximum payable amount to upgrade; and
the transaction fee corresponding to each request of loss among the first seat change request and the one or more matching seat change requests is respectively greater than or equal to a minimum receivable amount to downgrade.

12. The data processing device for making seating changes of claim 11, wherein the predetermined fee is an average actual change fee or a default change fee based on the location data.

13. The data processing device for making seating changes of claim 9, further comprising:
a verifying unit for verifying whether a confirmation corresponding to the first seat change request and the one or more matching seat change requests is received, prior to executing the first seat change request and the one or more matching seat change requests.

14. The data processing device for making seating changes of claim 9, further comprising:
a locking unit locking the first seat change request and the one or more matching seat change requests in the seat change requests, prior to executing the first seat change request and the one or more matching seat change requests.

15. The data processing device for making seat changes of claim 9, wherein location data further comprises data regarding mutual positional relationships among a plurality of seats.

16. The data processing device for making seat changes of claim 9, wherein the location data further comprises data regarding information of people in adjacent locations after seat change.

17. An electronic device, comprising:
a processor and a memory in which is stored a computer program instruction, the computer program instruction when executed by the processor causing the processor to perform a data processing method for making seating changes, the method comprising:
acquiring seat change requests wherein the seat change request comprises location data regarding a location change and fee data regarding a change fee;
selecting a first seat change request from the seat change requests wherein the first seat change request has a highest change fee;
determining one or more matching seat change requests corresponding to the first seat change request based on a predetermined matching policy; and
executing the first seat change request and the one or more matching seat change requests.

18. The device of claim 17, wherein determining one or more matching seat change requests corresponding to the first seat change request based on the predetermined matching policy comprises:
determining transaction fees corresponding to the first seat change request and the one or more matching seat change requests;
determining the one or more matching seat change requests corresponding to the first seat change request by a transaction fee based fee matching policy.

19. The device of claim 18, wherein the transaction fee based fee matching policy comprises:
a sum of transaction fees corresponding to the one or more matching seat change requests is minimum;
the transaction fee corresponding to the first seating change request is a predetermined fee based on the location data;
the transactions fee corresponding to each upgrade request among the first seat change request and the one or more matching seat change requests is respectively less than or equal to a maximum payable amount to upgrade; and
the transaction fee corresponding to each downgrade request among the first seat change request and the one or more matching seat change requests is respectively greater than or equal to a minimum receivable amount to downgrade.
